(19) United States
(12) Patent Application Publication
(10) Pub. No.: US 2026/0255282 A1
(43) Pub. Date: Aug. 27, 2026

(54) SYSTEM AND METHOD FOR MONITORING HARDWARE ALARMS IN RADIO SYSTEM

(71) Applicant: JIO PLATFORMS LIMITED, Ahmedabad (IN)

(72) Inventors: Pradeep Kumar BHATNAGAR, Navi Mumbai (IN); Deepak GUPTA, Navi Mumbai (IN); Nekiram KHOSYA, Dombivali (E) (IN); Satyajit SAHOO, Navi Mumbai (IN); Aayush BHATNAGAR, Navi Mumbai (IN)

(73) Assignee: JIO PLATFORMS LIMITED, Ahmedabad (IN)

(21) Appl. No.: 18/992,285

(22) PCT Filed: May 21, 2024
(86) PCT No.: PCT/IN2024/050594

§ 371 Date: Jan. 8, 2025

(30) Foreign Application Priority Data
Jun. 27, 2023 (IN) 202321043153

(51) Int. Cl. H04W 52/36

(52) U.S. Cl. CPC H04W 52/367

(57) ABSTRACT

The present disclosure provides a system and a method for monitoring hardware alarms in a radio system. The present disclosure enables real-time monitoring of Radio Frequency (RF) chains output power, and failures in Fifth Generation (5G) New Radio (NR) system without a need of any external measurement device. The present disclosure may improve 5G radio system performance and reliability by monitoring high, low transmit power, and chain failure in the radio system. The present disclosure determines the reflections occurring at an output port of a power amplifier under high power condition till an antenna port.

### RESERVATION OF RIGHTS

A portion of the disclosure of this patent document contains material which is subject to intellectual property rights such as, but are not limited to, copyright, design, trademark, integrated circuit (IC) layout design, and/or trade dress protection, belonging to Jio Platforms Limited (JPL) or its affiliates (hereinafter referred as owner). The owner has no objection to the facsimile reproduction by anyone of the patent document or the patent disclosure, as it appears in the Patent and Trademark Office patent files or records, but otherwise reserves all rights whatsoever. All rights to such intellectual property are fully reserved by the owner.

### TECHNICAL FIELD

The present disclosure relates to a field of performance monitoring and fault detection in Fifth-Generation (5G) radio systems, and specifically to a system and a method for monitoring hardware alarms in a radio system.

### BACKGROUND

The following description of related art is intended to provide background information pertaining to the field of the disclosure. This section may include certain aspects of the art that may be related to various features of the present disclosure. However, it should be appreciated that this section be used only to enhance the understanding of the reader with respect to the present disclosure, and not as admissions of prior art.

In general, a typical Fifth-Generation (5G) New Radio (NR) system includes a transmit chain(s) with a link budget such that a particular output power is radiated as per region-specific regulation norms. Higher transmit power than expected power may cause saturation of the power amplifier, leading to non-linearities, overall signal degradation, and non-compliance with regional telecom regulatory laws. Similarly, low transmit power may lead to lower coverage and poor user experience.

There is, therefore, a need in the art to improve the state of ensuring optimal radio system performance in a cost-effective manner by overcoming the deficiencies of the prior arts.

### SUMMARY

In an exemplary embodiment, a method for monitoring hardware alarms for a plurality of conditions in a radio network is described. The method comprises capturing, by a digital pre-distortion (DPD) application, a predefined number of DPD data samples over a pre-defined time period. The DPD data samples include values of a transmit power to a radio frequency (RF) antenna and a feedback power received from the RF antenna. In addition, the method includes filtering, by a processing module, valid DPD data samples from the DPD data samples. A DPD data sample is invalid if the transmit power or the feedback power is negative, infinity or zero, and the DPD data sample is valid if a difference between the transmit power and the feedback power is less than a maximum difference between the transmit power and the feedback power. The method includes analyzing, by the processing module, the valid DPD data samples to compare the transmit power against a first transmit threshold value and a second transmit threshold, and the feedback power against a first feedback threshold value and a second feedback threshold value. The method further includes, on determining that the transmit power and the feedback power are greater than the first transmit threshold value and the first feedback threshold value, respectively, incrementing, by the processing module, a high transmit power alarm counter. On determining that the transmit power and the feedback power are less than the second transmit threshold value and the second feedback threshold value, respectively, incrementing, by the processing module, a low transmit power alarm counter.

In some embodiments, the method comprises determining whether the high transmit power alarm counter is greater than a first predefined threshold count for first predefined consecutive intervals, and on determining that the high transmit power alarm counter is greater than the first predefined threshold count for the first predefined consecutive intervals, triggering a high transmit power alarm.

In some embodiments, the method comprises determining whether the low transmit power alarm counter is greater than a second predefined threshold count for second predefined consecutive intervals and on determining that the low transmit power alarm counter is greater than the second predefined threshold count for the second predefined consecutive intervals, triggering a low transmit power alarm.

In some embodiments, the method comprises, on detecting that DPD data samples in the captured DPD data samples are invalid for a first pre-defined consecutive time period, incrementing an invalid data counter, and determining whether a count in the invalid data counter is greater than a threshold invalid data count. The method further comprises, on determining that the count is greater than the threshold invalid data count, triggering a transmit chain failure alarm.

In some embodiments, determining whether a count of the low transmit power alarm counter is above a count threshold over a second pre-defined consecutive time period, and on determining that the count is above the count threshold over the second pre-defined consecutive time period, triggering the transmit chain failure alarm.

In some embodiments, the method comprises when at least one of DPD data sample in the predefined consecutive number of DPD data samples is a valid sample, resetting the invalid data counter to zero.

In some embodiments, determining the first transmit threshold value and the first feedback threshold value comprises capturing the transmit power value and the feedback power value for the second predefined number of DPD data samples and determining a maximum value for the transmit power and a maximum value for the feedback power from the second predefined data samples. The maximum value determined for the first transmit power value is the first transmit threshold value. The maximum value determined for the feedback power is the first feedback threshold value.

In some embodiments, for calculating the second predefined threshold count for the low transmit power alarm counter comprises capturing the transmit power value and the feedback power value for the first predefined numbers of DPD data samples and determining a minimum value for the transmit power and the feedback power from the predefined data samples. The first predefined threshold count for the low transmit power alarm counter is the minimum value of the transmit power and the feedback power, respectively.

In some embodiments, the predefined number of DPD data samples comprises fifteen data samples, the predefined consecutive intervals are four, and the first and second predefined consecutive hours are four hours.

In another exemplary embodiment, a hardware alarm monitoring system comprising an application-specific integrated circuit (ASIC) and a transceiver chain is described. The system further comprises the ASIC comprising a processing module and a digital pre-distortion (DPD) application. The transceiver chain comprises a transmit chain configured to monitor a transmit power to a radio frequency (RF) antenna and a feedback chain to monitor a feedback power from the RF antenna port. A DPD application configured to capture a predefined number of digital pre-distortion (DPD) data samples over a pre-defined time period. The DPD data samples comprise the transmit power and the feedback power of the RF antenna port. The processing module is configured to filter valid DPD data samples from the DPD data samples. The DPD data sample is invalid if the transmit power or the feedback power is negative, infinity or zero and the DPD data sample is valid if a difference between the transmit power and the feedback power is less than a maximum difference between the transmit power and the feedback power. The processing module is configured to analyze the valid DPD data samples to determine whether the transmit power is greater than the transmit threshold value and whether the feedback power is less than the feedback threshold value of the transmit power and the feedback power. On determining that the transmit power and the feedback power are greater than the transmit threshold value and the feedback threshold value, respectively, the processing module configured to increment a high transmit power alarm counter. On determining that the transmit power and the feedback power are less than the transmit threshold value and the feedback threshold value, respectively, the processing module configured to increment a low transmit power alarm counter.

In some embodiments, the processing module configured to determine whether the high transmit power alarm counter is greater than a first predefined threshold count for first predefined consecutive intervals. On determining that the high transmit power alarm counter is greater than the first predefined threshold count for the first predefined consecutive intervals, the processing module configured to trigger a high transmit power alarm.

In some embodiments, the processing module is configured to determine whether the low transmit power alarm counter is greater than a second predefined threshold count for second predefined consecutive intervals. On determining that the low transmit power alarm counter is greater than the second predefined threshold count for the second predefined consecutive intervals, the processing module is configured to trigger a low transmit power alarm.

In some embodiments, upon detecting that a predefined consecutive number of DPD data samples in the captured DPD data samples are invalid, the processing module is configured to increment an invalid data counter and determine whether a count in the invalid data counter is above a threshold invalid data count over a first pre-defined consecutive time period. On determining that the count is greater than the threshold invalid data count over the first pre-defined consecutive time period, the processing module is configured to trigger a transmit chain failure alarm.

In some embodiments, the processing module is configured to determine whether a count of the low transmit power alarm counter is above a count threshold over a second pre-defined consecutive time period and on determining that the count is above the count threshold over the second pre-defined consecutive time period, trigger the transmit chain failure alarm.

In some embodiments, when at least one DPD data sample of a first predefined number of DPD data samples is valid, the processing module is configured to reset the invalid data counter to zero.

In some embodiments, determining the first transmit threshold value and the first feedback threshold value comprising capture the transmit power value and the feedback power value for a second predefined number of DPD data samples and determine a maximum value for the transmit power and the feedback power from the second predefined DPD data samples. The maximum value determined for the first transmit power value is the first transmit threshold value. The maximum value determined for the feedback power is the first feedback threshold value.

In some embodiments, for calculating the threshold value for the low transmit power alarm counter, the processing module is configured to capture the transmit power value and the feedback power value for the predefined data samples and determine a minimum value for the transmit power and the feedback power from the predefined data samples. The threshold value for the low transmit power alarm counter is the minimum value of the transmit power and the feedback power.

In some embodiments, the predefined number of DPD data samples comprises fifteen data samples, the predefined consecutive intervals are four, and the first pre-defined consecutive hours and the second pre-defined consecutive hours are four hours.

In some embodiments, a user equipment is communicatively coupled with a base station via a network. The base station comprises a radio frequency antenna communicating with a hardware alarm monitoring system. The hardware alarm monitoring system is configured to capture a predefined number of digital pre-distortion (DPD) data samples from a DPD application over a pre-defined time period. The DPD data samples include values of a transmit power to a radio frequency (RF) antenna and a feedback power received from the RF antenna. The hardware alarm monitoring system is configured to filter valid DPD data samples from the DPD data samples. The DPD data sample is invalid if the transmit power or the feedback power is negative, infinity, or zero, and the DPD data sample is valid if a difference between the transmit power and the feedback power is less than a maximum difference between the transmit power and the feedback power. The hardware alarm monitoring system is configured to analyze the valid DPD data samples to determine whether the transmit power is greater than a transmit threshold value, and the feedback power is less than a feedback threshold value of the transmit power and the feedback power. on determining that transmit power and the feedback power are greater than the transmit threshold value and the feedback threshold value, respectively, the hardware alarm monitoring system is configured to increment a high transmit power alarm counter. On determining that the transmit power and the feedback power are less than the transmit threshold value and the feedback threshold value, respectively, the hardware alarm monitoring system is configured to increment a low transmit power alarm counter.

### OBJECTS OF THE PRESENT DISCLOSURE

It is an object of the present disclosure to monitor high, low transmit power, and chain failure in a radio system.

It is an object of the present disclosure to enable real-time monitoring of Radio Frequency (RF) chain failures without a need of any external measurement device.

It is an object of the present disclosure to improve performance and reliability of the radio system.

It is an object of the present disclosure to ensure optimal radio system performance in a cost-effective manner.

It is an object of the present disclosure to reduce operating expenses or expenditure (OPEX) cost and failure turnaround time of operators.

It is an object of the present disclosure to improvise the fault detection techniques and real time monitoring of the alarms.

It is an object of the present disclosure to provide an integrated single unit system.

### BRIEF DESCRIPTION OF THE DRAWINGS

In the figures, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

The diagrams are for illustration only, which thus is not a limitation of the present disclosure, and wherein:

FIG. 1 illustrates an exemplary network architecture (100) in which or with which embodiments of the present disclosure may be implemented.

FIG. 2 illustrates an exemplary architecture (200) of a hardware alarm monitoring system (108), in accordance with an embodiment of the present disclosure.

FIG. 3A illustrates an exemplary flow chart (300A) of a high transmit power alarm, a low transmit power alarm and a transmission chain failure alarm, in accordance with an embodiment of the present disclosure.

FIG. 3B illustrates an exemplary flow chart (300B) of a high transmit power alarm, a low transmit power alarm and a transmission chain failure alarm, in accordance with an embodiment of the present disclosure.

FIG. 4 illustrates an exemplary computer system (400) in which or with which embodiments of the present disclosure may be implemented.

### DETAILED DESCRIPTION

The following is a detailed description of embodiments of the disclosure depicted in the accompanying drawings. The embodiments are in such detail as to clearly communicate the disclosure. However, the amount of detail offered is not intended to limit the anticipated variations of embodiments; on the contrary, the intention is to cover all modifications, equivalents, and alternatives falling within the spirit and scope of the present disclosure as defined by the appended claims.

Generally, a typical Fifth-generation (5G) New Radio (NR) system includes a transmit chain(s) with a link budget such that a particular output power is radiated as per region specific regulation norms. Higher transmit power than expected power may cause saturation of power amplifier leading to non-linearities, overall signal degradation and non-compliance with regional telecom regulatory laws. Similarly, low transmit power may lead to lower coverage and poor user experience.

The proposed system may combine advanced signal processing techniques along with innovative hardware design enabling real-time monitoring of Radio Frequency (RF) chains output power, and failures in 5G NR radios without the need of any external measurement device. The proposed system may improve 5G radio system performance and reliability by monitoring a high transmit power, a low transmit power, and a transmit chain failure in the radio system.

The proposed system may determine the reflections occurring at an output port of a power amplifier under a high power condition till an antenna port. Thereby, providing a valuable tool for radio operators and technicians in ensuring optimal radio system performance in a cost-effective manner. The proposed system may reduce operating expenses or expenditure (OPEX) costs and the failure turnaround time of the operators.

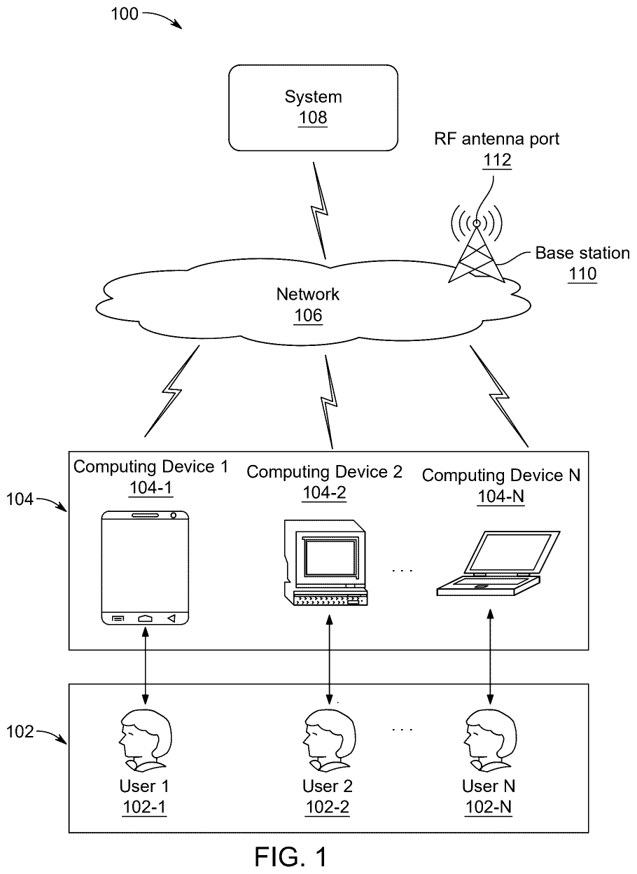

The various embodiments of the present disclosure will be explained in detail with reference to FIGS. 1 to 4.

FIG. 1 illustrates an exemplary network architecture (100) in which or with which embodiments of the present disclosure may be implemented.

Referring to FIG. 1, the network architecture (100) may include one or more user equipments (104-1, 104-2 . . . 104-N) associated with one or more users (102-1, 102-2 . . . 102-N) in an environment. A person of ordinary skill in the art will understand that one or more users (102-1, 102-2 . . . 102-N) may be individually referred to as the user (102) and collectively referred to as the users (102). Similarly, a person of ordinary skill in the art will understand that one or more user equipments (104-1, 104-2 . . . 104-N) may be individually referred to as the user equipment (104) and collectively referred to as the user equipment (104). A person of ordinary skill in the art will appreciate that the terms “computing device(s)” and “user equipment” may be used interchangeably throughout the disclosure. Although three user equipments (104) are depicted in FIG. 1, however any number of the user equipments (104) may be included without departing from the scope of the ongoing description.

In an embodiment, the user equipment (104) may include smart devices operating in a smart environment, for example, an Internet of Things (IOT) system. In such an embodiment, the user equipment (104) may include, but is not limited to, smartphones, smart watches, smart sensors (e.g., mechanical, thermal, electrical, magnetic, etc.), networked appliances, networked peripheral devices, networked lighting system, communication devices, networked vehicle accessories, networked vehicular devices, smart accessories, tablets, smart television (TV), computers, smart security system, smart home system, other devices for monitoring or interacting with or for the users (102) and/or entities, or any combination thereof. A person of ordinary skill in the art will appreciate that the user equipment (104) may include, but is not limited to, intelligent, multi-sensing, network-connected devices, that can integrate seamlessly with each other and/or with a central server or a cloud-computing system or any other device that is network-connected.

In an embodiment, the user equipment (104) may include, but is not limited to, a handheld wireless communication device (e.g., a mobile phone, a smartphone, a phablet device, and so on), a wearable computer device(e.g., a head-mounted display computer device, a head-mounted camera device, a wristwatch computer device, and so on), a Global Positioning System (GPS) device, a laptop computer, a tablet computer, or another type of portable computer, a media playing device, a portable gaming system, and/or any other type of computer device with wireless communication capabilities, and the like. In an embodiment, the user equipment (104) may include, but is not limited to, any electrical, electronic, electro-mechanical, or an equipment, or a combination of one or more of the above devices, such as virtual reality (VR) devices, augmented reality (AR) devices, laptop, a general-purpose computer, desktop, personal digital assistant, tablet computer, mainframe computer, or any other computing device, wherein the user equipment (104) may include one or more in-built or externally coupled accessories including, but not limited to, a visual aid device such as a camera, an audio aid, a microphone, a keyboard, and input devices for receiving input from the user (102) or the entity such as touchpad, touch-enabled screen, electronic pen, and the like. A person of ordinary skill in art will appreciate that the user equipment (104) may not be restricted to the mentioned devices and that various other devices may be used.

Referring to FIG. 1, the user equipment (104) may communicate with a system (108), for example, a hardware alarm monitoring system, through a network (106). In an embodiment, the network (106) may include at least one of a Fifth-Generation (5G) network, a Sixth-Generation (6G) network, or the like. The network (106) may enable the user equipment (104) to communicate with other devices in the network architecture (100) and/or with the system (108). The network (106) may include a wireless card or some other transceiver connection to facilitate this communication. In another embodiment, the network (106) may be implemented as, or include any of a variety of different communication technologies such as a wide area network (WAN), a local area network (LAN), a wireless network, a mobile network, a Virtual Private Network (VPN), the Internet, the Public Switched Telephone Network (PSTN), or the like. In an aspect, the network (106) may include a base station (110). The base station may include a radio antenna (112). In an embodiment, the network (106) may include one or more base stations. The base station is a wireless communications station installed at a fixed location and used to communicate with the user equipment (104). The base station is a radio receiver/transmitter that serves as the hub of the local wireless network and may also be the gateway between a wired network and the wireless network. The system (108) may be used to monitor the high transmit power, the low transmit power, and the feedback power of the radio antenna (112) of the base station.

In accordance with embodiments of the present disclosure, the system (108) may be designed and configured for enabling real-time monitoring of RF chains output power, and failures in 5G NR radios without the need of any external measurement device. The system (108) may improve 5G radio system performance and reliability by monitoring high, low transmit power, and chain failure in the radio system. The system (108) may determine the reflections occurring at an output port of a power amplifier under high power condition till an antenna port. Thereby, providing a valuable tool for radio operators and technicians in ensuring optimal radio system performance in a cost-effective manner. The system (108) may reduce OPEX cost and failure turnaround time of the operators.

Although FIG. 1 shows exemplary components of the network architecture (100), in other embodiments, the network architecture (100) may include fewer components, different components, differently arranged components, or additional functional components than depicted in FIG. 1. Additionally, or alternatively, one or more components of the network architecture (100) may perform functions described as being performed by one or more other components of the network architecture (100).

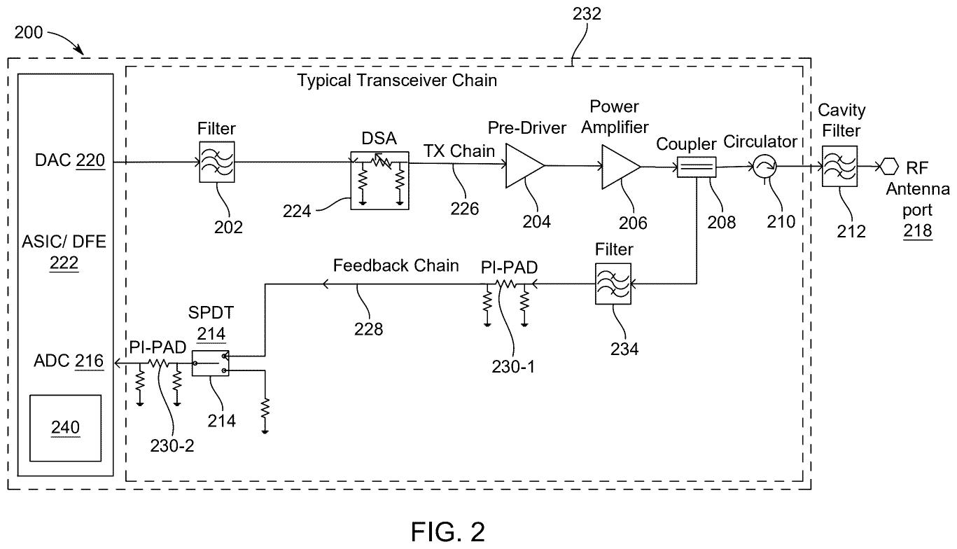

FIG. 2 illustrates an exemplary architecture (200) of the hardware alarm monitoring system (108), in accordance with an embodiment of the present disclosure.

With respect to FIG. 2, the cost-effective hardware alarm monitoring system (108) may include an application-specific integrated circuits/digital front end (ASIC/DFE) (222) and a transceiver chain (232). The hardware alarm monitoring system (108) may be used to monitor high transmit power, low transmit power, and feedback power of a radio frequency (RF) antenna port (218) via a cavity filter (212). The ASIC/DFE (222) comprises a digital-to-analog converter (DAC) (220) and an analog-to-digital converter (ADC) (216). The transceiver chain (232) comprises a transmit chain (226) and a feedback chain (228). The transmit chain comprises a filter (202), a dynamic spectrum access (224), a pre-driver (204), a power amplifier (PA) (206), a coupler (208), a circulator (210), and the cavity filter (212). The feedback chain (228) comprises a filter (234), a first PI-PAD (230-1), a single pole double throw (SPDT) switch (214), and a second PI-PAD (230-2). The feedback chain (228) is used to monitor feedback power from the RF antenna port (218). The ASIC/DFE (222) may include a digital pre-distortion (DPD) application. The hardware alarm monitoring system (108) may include a processing module (240). The processing module (240) may perform one or more of the following functions. The ASIC/DFE (222) includes a digital pre-distortion (DPD) application. The DPD application may seek to characterize distortion by analyzing the PA output and altering the input signal so that the PA output may be as ideal as possible. The hardware alarm monitoring system (108) may use transmitted and feedback power at the DPD application to calculate hardware alarms like high and low transmit chain power and transmit chain failure.

In an aspect, the DAC (220) may convert a digital input signal into an analog output signal.

The filter (234) may detect and filter out carrier frequency.

The pre-driver (204) may used to tune a driver to control the driver to match the electrical properties of the driver with the other electrical elements of the system. The pre-driver (204) is coupled to the driver and supplies the control signals to the driver circuit.

The power amplifier (206) is an electronic amplifier designed to increase the magnitude of power of a given input signal.

The couplers (208) are used to distribute, combine, or sample signals.

The circulator (210) is a device that allows signals to exit through a port directly after the one it entered.

The cavity filter (212) is a type of filter that operates on the principle of resonance.

The SPDT switch (214) consists of three terminals and connects the source terminal and one of two output terminals. The SPDT switch (214) allows for an “ON/ON” configuration (i.e., the switch's input terminal is always completing one of the two possible circuits that the switch controls).

The ADC (216) is used to convert an analog signal such as a voltage to a digital form.

The ASIC is an integrated circuit (IC) that is designed for a particular task or application. The digital front-end is the part of the transceiver implementing front-end functionalities (e.g., frequency conversion and channel filtering).

The DPD application may apply inverse distortion, using a pre-distorter, at the input signal of the power amplifier (PA) to cancel the distortion generated by the power amplifier (PA).

The hardware alarm monitoring system (108) may process DPD transmit power (also referred to as transmit power) and feedback power observed at the DPD application. The DPD transmit power is a power transmitted from the ASIC/DFE (222) towards the RF antenna port. The DPD feedback power is a reflected power from the RF antenna port received at the ASIC/DFE. In a live network, the DPD transmit power, and the feedback power may be polled every predefined time period (e.g., 15 minutes) or more. Based on different thresholds defined based on data analyzed from different test cases, different alarms may be raised. Before analyzing the DPD data samples, the DPD data samples may be captured over a pre-defined time period. In an example, the predefined number may be 15 samples. For example, the predefined time period may be 15 minutes. The DPD data samples may include values of a transmit power to the RF antenna 112 and a feedback power received from the RF antenna (112). A processing module may filter the valid data samples from the captured DPD data samples. The DPD data sample may be invalid if the transmit power or the feedback power is negative, infinity or zero. The DPD data sample may be valid if a difference between the transmit power and the feedback power is less than a maximum difference between the transmit power and the feedback power.

The entire process, starting from the method of filtering DPD samples to calculating thresholds for each alarm condition, may be explained in the following steps.

Step 1: Conditions for filtering valid DPD data samples: The valid DPD data samples may be filtered by the DPD application on the basis of the following analysis.
a. For example, fifteen DPD data samples or more may be collected over fifteen minutes or user configurable, and only valid ones may be analyzed further. The condition for filtering valid data samples is mentioned in the following points.
b. If either the DPD transmit or feedback power value is negative infinity or 0, then the DPD data sample for the chain may be invalid.
c. The valid DPD data samples are analyzed to determine the minimum power condition and maximum power condition.
d. With DPD data analyzed from step c, a maximum difference between DPD transmit and feedback power is noted as Max|dpd,tx−dpd,fb|_{,i} for i-th chain. All data samples observed with DPD transmit and received feedback power difference less than Max|dpd,tx−dpd, fb|_{,i} may be valid, and the rest of the DPD data samples may be invalid.
e. If all the fifteen DPD data samples or more are invalid as suggested above, the invalid data counter may be incremented by one. This counter may be reset to zero if at least one of the fifteen data samples or more are valid in any future iteration.

Step 2: Conditions for triggering low transmit power alarm: Low transmit power alarm may be triggered by the processing module (240) based on transmit and feedback power received at DPD application in the DFE. The thresholds for low transmit power may be derived from following steps. The analysis may be done on a calibrated golden radio setup.
a. Radio may be configured to radiate fixed buffers with Third-Generation Partnership Project (3GPP) based NR FR1 Test Model 2a (NR-FR1-TM2a) for a low load condition. The radio system may be on its minimum transmission (TX) power possible as only one physical resource block (PRB) is allocated.
b. The DPD transmit and feedback power may be captured for all chains separately for a second predefined number of DPD data samples (for example, 100 data samples). The minimum of the 100 data samples may be noted for each chain. The final threshold values are Tx_{dpd_tm2a_min,i} (a second transmit threshold) and Fb_{dpd_tm2a_min,i} (a second feedback threshold) for i-th chain.
c. In live network, the DPD transmit, and feedback power may be polled every predefined time period (e.g., 15 minutes) or user configurable. If DPD transmit has values<Tx_{dpd_tm2a_min,i} and feedback power has values<Fb_{dpd_tm2a_min,i}, then counter for low transmit power may be incremented.
d. The counter may be reset to 0 if DPD transmit and feedback values observed are greater than Tx_{dpd_tm2a_min,i} and Fb_{dpd_tm2a_min,i} in any iteration.
e. If the counter is greater than or equal (a second predefined threshold count) to second predefined consecutive intervals (e.g., 4 hours/(15 minutes*16=4 hours)), then a low transmit power alarm may be triggered. The alarm may be kept alive till the condition in step d is met. The second predefined consecutive intervals are time periods defined for the counter for particular conditions to be occurred.

Step 2: Conditions for triggering high transmit power alarm: High transmit power alarm may be triggered by the processing module (240) based on transmit and feedback power received at DPD application in the DFE. The thresholds for high transmit power may be derived from following steps. The analysis is done on a calibrated golden radio setup.
a. Radio may be configured to radiate fixed buffers with 3GPP based NR FR1 test model 3.1a (NR-FR1-TM3.1a). The radio system may be on its maximum TX power possible as all the PRBs are allocated.
b. DPD transmit and feedback power may be captured for all chains separately for pre-defined number (e.g., 100) data samples. The maximum of the 100 data samples may be noted for each chain. The final threshold values are Tx_{dpd_full_load,i} (that is, a first transmit threshold) and Fb_{dpd_full_load,i} (that is, a first feedback threshold) for i-th chain.
c. In live network, the DPD transmit, and feedback power may be polled every pre-defined time period (e.g., 15 minutes) or user configurable. If DPD transmit has values>Tx_{dpd_full_load,i} and feedback power has values>Fb_{dpd_full_load,i}, then counter for high transmit power may be incremented.
d. The counter may be reset to 0 if DPD transmit and feedback values observed are less than Tx_{dpd_full_load,i} and Fb_{dpd_full_load,i} in any iteration.
e. If the counter is greater than or equal (the first predefined threshold count) to first predefined consecutive intervals (e.g., 4), then high transmit power alarm may be triggered. The alarm may be kept raised till condition in step d is met.

Step 3: Conditions for triggering transmit chain failure alarm by the processing module (240): The conditions for triggering transmit chain failure alarm may be defined as follows:
a. If invalid data for a first pre-defined consecutive time period (e.g., 4 hours) (a first pre-defined consecutive time period) or more is received, the invalid data counter may be incremented to predefined consecutive intervals (for example, 16) or more (a threshold invalid data count). This invalid data time may be configurable based on the network requirements. The network requirements may include network traffic, network coverage, signal quality, user experience, and system performance.
b. If low transmit power alarm for a second pre-defined consecutive time period (e.g., 4 hours) (a second pre-defined consecutive time period) or more is received, the low transmit power alarm counter may be incremented to predefined consecutive intervals (e.g., 16) or more. This transmit low power alarm time may be configurable based on the network requirements.

Although FIG. 2 shows an exemplary architecture (200) of the hardware alarm monitoring system (108), in other embodiments, the hardware alarm monitoring system (108) may include fewer components, different components, differently arranged components, or additional functional components than depicted in FIG. 2. Additionally, or alternatively, one or more components of the hardware alarm monitoring system (108) may perform functions described as being performed by one or more other components of the hardware alarm monitoring system (108).

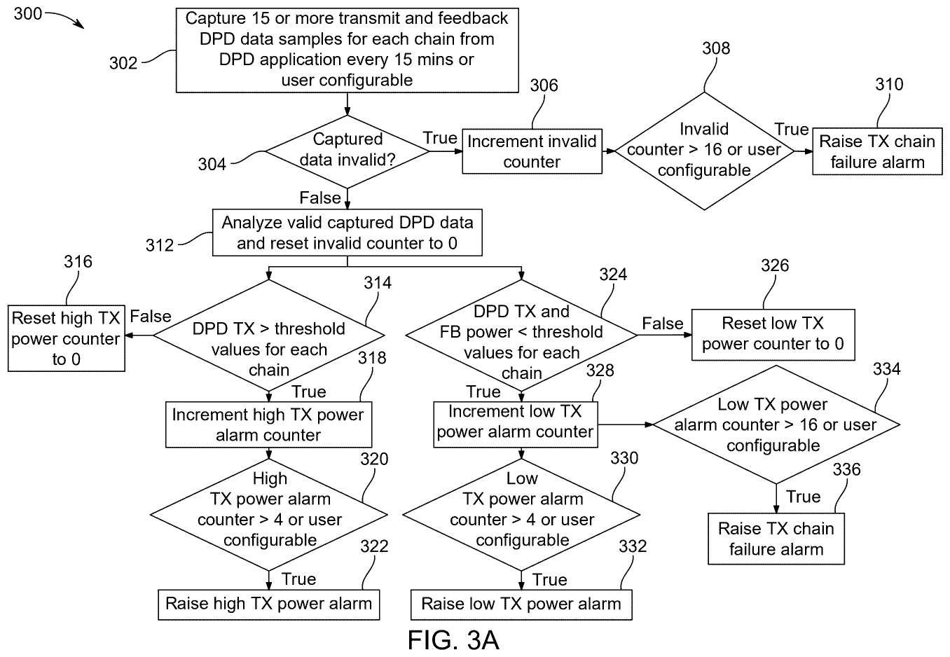

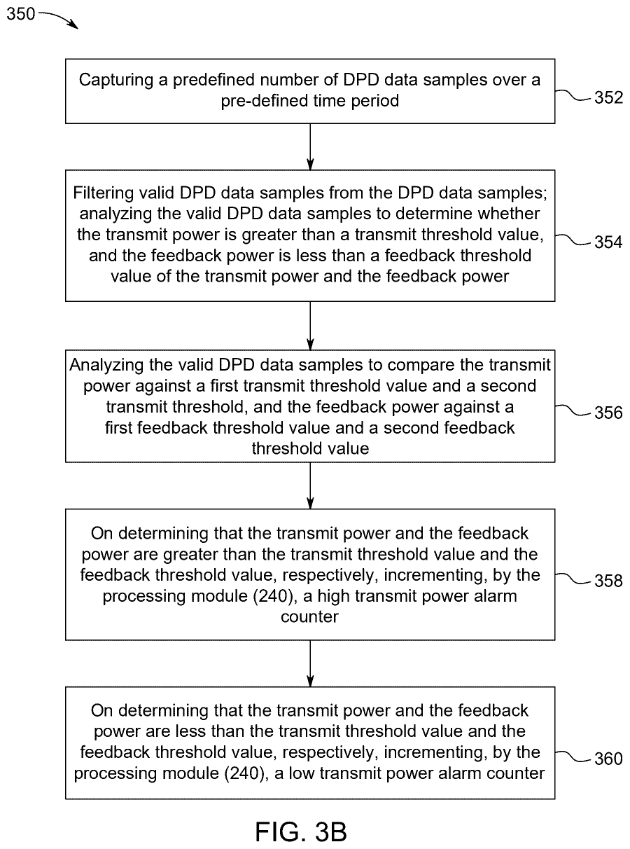

FIG. 3A illustrates an exemplary flow chart (300) of high and low transmit power and transmit chain failure alarms, in accordance with an embodiment of the present disclosure.

With respect to FIG. 3A, at 302, 15 or more transmit and feedback DPD data samples may be captured for each chain from the DPD application every 15 minutes or user configurable.

At 304, the hardware alarm monitoring system (108) may determine whether the captured data is invalid.

If the captured data is invalid, an invalid data counter may be incremented at 306. Further, the hardware alarm monitoring system (108) may determine if the invalid data counter is greater than a threshold invalid data count (for example, predefined consecutive intervals such as 16) or user configurable at 308. If the invalid data counter is greater than predefined consecutive intervals (e.g., 16) or user configurable, the transmit chain failure alarm may be triggered at 310.

If the captured data is valid, the valid captured data may be analysed, and the invalid data counter may be set to 0 at 312.

In an embodiment, at 314, the hardware alarm monitoring system (108) may determine if the DPD transmit power is greater than threshold values. If the DPD transmit power is lesser than the threshold values, then a high transmit power counter may be set to 0 at 316.

At 318, if the DPD transmit and feedback power is greater than the threshold values, the high transmit power alarm counter may be incremented. Further, the hardware alarm monitoring system (108) may determine whether the high transmit power alarm counter is greater than a first predefined threshold count (for example, four or any user-configurable count) for the first predefined consecutive intervals, at 320. At 322, the high transmit power alarm may be triggered on the determination that the high transmit power alarm counter is greater than the first predefined threshold count for the first predefined consecutive intervals.

In an embodiment, at 324, the hardware alarm monitoring system (108) may determine if the DPD transmit, and feedback power is lesser than the threshold values. If the DPD transmit and feedback power is greater than the threshold values, then a low transmit power counter may be set to 0 at 326.

At 328, if the DPD transmit and feedback power is lesser than the threshold values, the low transmit power alarm counter may be incremented. Further, the hardware alarm monitoring system (108) may determine whether the low transmit power alarm counter is greater than a second predefined threshold count (e.g., 4) or user-configurable count for the second predefined consecutive intervals, at 330. At 332, the low transmit power alarm may be triggered on the determining that the low transmit power alarm counter is greater than a second predefined threshold count at predefined consecutive intervals (e.g., 4) or user-configurable.

In an embodiment, upon incrementing the low transmit power alarm counter, the hardware alarm monitoring system (108) may determine whether the low transmit power alarm counter is greater than 16 or user configurable, at 334. At 336, the transmit chain failure alarm may be triggered on the determination that the low transmit power alarm counter is greater than 16 or user configurable.

FIG. 3B illustrates an exemplary flow chart (300B) of high and low transmission power and transmission chain failure alarms, in accordance with an embodiment of the present disclosure.

At step 352 of the flow diagram (300B), the DPD application captures a predefined number of DPD data samples over a predefined time period.

At step 354, the processing module (240) filters valid data samples from the DPD samples. The DPD data sample is invalid if the transmit power or the feedback power is negative, infinity or zero, and the DPD data sample is valid if a difference between the transmit power and the feedback power is less than a maximum difference between the transmit power and the feedback power.

At step 356, the processing module (240) analyzes the valid DPD data samples to compare the transmit power against a first transmit threshold value and a second transmit threshold, and the feedback power against a first feedback threshold value and a second feedback threshold value.

At step 358, on determining that the transmit power and the feedback power are greater than the first transmit threshold value and the first feedback threshold value, respectively, the processing module (240) increments a high transmit power alarm counter.

At step 360, on determining that the transmit power and the feedback power are less than the second transmit threshold value and the second feedback threshold value, respectively, the processing module (240) increments a low transmit power alarm counter.

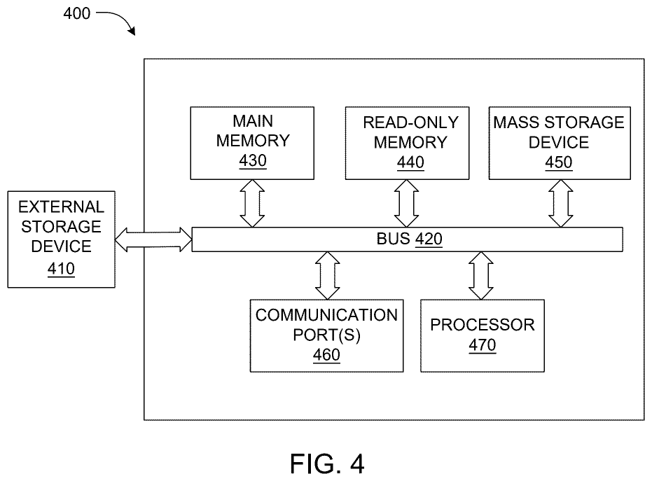

FIG. 4 illustrates an exemplary computer system (400) in which or with which embodiments of the present disclosure may be implemented. As shown in FIG. 4, the computer system (400) may include an external storage device (410), a bus (420), a main memory (430), a read only memory (440), a mass storage device (450), a communication port (460), and a processor (470). A person skilled in the art will appreciate that the computer system (400) may include more than one processor (470) and communication ports (460). Processor (470) may include various modules associated with embodiments of the present disclosure.

In an embodiment, the communication port (460) may be any of an RS-232 port for use with a modem-based dialup connection, a 10/100 Ethernet port, a Gigabit or 10 Gigabit port using copper or fiber, a serial port, a parallel port, or other existing or future ports. The communication port (460) may be chosen depending on a network, such a Local Area Network (LAN), Wide Area Network (WAN), or any network to which the computer system (400) connects.

In an embodiment, the memory (430) may be Random Access Memory (RAM), or any other dynamic storage device commonly known in the art. Read-only memory (440) may be any static storage device(s) e.g., but not limited to, a Programmable Read Only Memory (PROM) chips for storing static information e.g., start-up or Basic Input/Output System (BIOS) instructions for the processor (470).

In an embodiment, the mass storage device (450) may be any current or future mass storage solution, which may be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces), one or more optical discs, Redundant Array of Independent Disks (RAID) storage, e.g., an array of disks (e.g., SATA arrays).

In an embodiment, the bus (420) communicatively couples the processor(s) (470) with the other memory, storage and communication blocks. The bus (420) may be, e.g., a Peripheral Component Interconnect (PCI)/PCI Extended (PCI-X) bus, Small Computer System Interface (SCSI), Universal Serial Bus (USB) or the like, for connecting expansion cards, drives and other subsystems as well as other buses, such a front side bus (FSB), which connects the processor (470) to the computer system (400).

Optionally, operator and administrative interfaces, e.g., a display, keyboard, joystick, and a cursor control device, may also be coupled to the bus (420) to support direct operator interaction with the computer system (400). Other operator and administrative interfaces may be provided through network connections connected through the communication port (460). Components described above are meant only to exemplify various possibilities. In no way should the aforementioned exemplary computer system (400) limit the scope of the present disclosure.

While the foregoing describes various embodiments of the present disclosure, other and further embodiments of the present disclosure may be devised without departing from the basic scope thereof. The scope of the present disclosure is determined by the claims that follow. The present disclosure is not limited to the described embodiments, versions or examples, which are included to enable a person having ordinary skill in the art to make and use the present disclosure when combined with information and knowledge available to the person having ordinary skill in the art.

### ADVANTAGES OF THE PRESENT DISCLOSURE

The present disclosure monitors high, low transmit power, and chain failure in a radio system.

The present disclosure enables real-time monitoring of Radio Frequency (RF) chain failures without a need of any external measurement device.

The present disclosure improves performance and reliability of the radio system.

The present disclosure ensures optimal radio system performance in a cost-effective manner.

The present disclosure reduces operating expenses or expenditure (OPEX) cost and failure turnaround time of operators. The present disclosure provides an enhanced radio system with alarm monitoring.

We claim:

1. A method for monitoring hardware alarms for a plurality of conditions in a radio network (106), the method comprising:
capturing, by a digital pre-distortion (DPD) application, a predefined number of DPD data samples over a pre-defined time period, wherein the DPD data samples include values of a transmit power to a radio frequency (RF) antenna (218) and a feedback power received from the RF antenna (218);
filtering, by a processing module (240), valid DPD data samples from the DPD data samples, wherein a DPD data sample is invalid if the transmit power or the feedback power is negative, infinity or zero, and the DPD data sample is valid if a difference between the transmit power and the feedback power is less than a maximum difference between the transmit power and the feedback power;
analyzing, by the processing module (240), the valid DPD data samples to compare the transmit power against a first transmit threshold value and a second transmit threshold, and the feedback power against a first feedback threshold value and a second feedback threshold value;
upon determining that the transmit power and the feedback power are greater than the first transmit threshold value and the first feedback threshold value, respectively, incrementing, by the processing module (240), a high transmit power alarm counter; and
upon determining that the transmit power and the feedback power are less than the second transmit threshold value and the second feedback threshold value, respectively, incrementing by the processing module (240), a low transmit power alarm counter.

2. The method claimed as in claim 1, further comprising:
determining whether the high transmit power alarm counter is greater than a first predefined threshold count for first predefined consecutive intervals; and
upon determining that the high transmit power alarm counter is greater than the first predefined threshold count for the first predefined consecutive intervals, triggering a high transmit power alarm.

3. The method claimed as in claim 1, further comprising:
determining whether the low transmit power alarm counter is greater than a second predefined threshold count for second predefined consecutive intervals; and
upon determining that the low transmit power alarm counter is greater than the second predefined threshold count for the second predefined consecutive intervals, triggering a low transmit power alarm.

4. The method claimed as in claim 1, further comprising:
upon detecting that DPD data samples in the captured DPD data samples are invalid for a first pre-defined consecutive time period, incrementing an invalid data counter;
determining whether a count in the invalid data counter is greater than a threshold invalid data count; and
upon determining that the count is greater than the threshold invalid data count, triggering a transmit chain failure alarm.

5. The method claimed as in claim 4, further comprising:
determining whether a count of the low transmit power alarm counter is above a count threshold over a second pre-defined consecutive time period; and
on determining that the count is above the count threshold over the second pre-defined consecutive time period, triggering the transmit chain failure alarm.

6. The method claimed as in claim 4, wherein when at least one of the DPD data samples in the predefined consecutive number of DPD data samples is a valid sample, resetting the invalid data counter to zero.

7. The method claimed as in claim 1, wherein determining the first transmit threshold value and the first feedback threshold value comprising:
capturing the transmit power value and the feedback power value for a second predefined number of DPD data samples; and
determining a maximum value for the transmit power and a maximum value for the feedback power from the second predefined data samples, wherein the maximum value determined for the first transmit power value is the first transmit threshold value and wherein the maximum value determined for the feedback power is the first feedback threshold value.

8. The method claimed as in claim 7, wherein for calculating the second transmit threshold value count for the low transmit power alarm counter comprising:
capturing the transmit power value and the feedback power value for the second predefined number of DPD data samples; and
determining a minimum value for the transmit power and the feedback power from the predefined data samples, wherein the second transmit threshold value and the second feedback threshold value are the minimum value of the transmit power and the feedback power, respectively.

9. The method claimed as in claim 5, wherein the predefined number of DPD data samples comprises fifteen data samples, the predefined consecutive intervals are four and the first predefined consecutive time period and the second predefined consecutive time period are four hours.

10. A hardware alarm monitoring system (108) comprising an application specific integrated circuit (ASIC) (222) and a transceiver chain (232), the system further comprising:
the ASIC (222) comprises a processing module (240), and a digital pre-distortion (DPD) application;
the transceiver chain (232) comprises a transmit chain configured to monitor a transmit power to a radio frequency (RF) antenna (218) and a feedback chain (228) to monitor a feedback power from the RF antenna port (218);
a DPD application configured to capture a predefined number of digital pre-distortion (DPD) data samples from the transmit chain and the feedback chain (228) over a pre-defined time period, wherein the DPD data samples comprises the transmit power and the feedback power of the RF antenna port;
the processing module (240) is configured to:
filter valid DPD data samples from the DPD data samples, wherein the DPD data sample is invalid if the transmit power or the feedback power is negative, infinity or zero and the DPD data sample is valid if a difference between the transmit power and the feedback power is less than a maximum difference between the transmit power and the feedback power;
analyze the valid DPD data samples to compare the transmit power against a first transmit threshold value and a second transmit threshold, and the feedback power against a first feedback threshold value and a second feedback threshold value;
upon determining that the transmit power and the feedback power are greater than the first transmit threshold value and the first feedback threshold value, respectively, increment, by the processing module (240), a high transmit power alarm counter; and
upon determining that the transmit power and the feedback power are less than the second transmit threshold value and the second feedback threshold value, respectively, increment by the processing module (240), a low transmit power alarm counter.

11. The system claimed as in claim 10 wherein the processing module (240) is configured to:
determine whether the high transmit power alarm counter is greater than a first predefined threshold count for first predefined consecutive intervals; and
upon determining that the high transmit power alarm counter is greater than the first predefined threshold count for the first predefined consecutive intervals, trigger a high transmit power alarm.

12. The system claimed as in claim 10, wherein the processing module (240) is configured to:
determine whether the low transmit power alarm counter is greater than a second predefined threshold count for second predefined consecutive intervals; and
on determining that the low transmit power alarm counter is greater than the second predefined threshold count for the second predefined consecutive intervals, trigger a low transmit power alarm.

13. The system claimed as in claim 10, further comprising:
upon detecting that a predefined consecutive number of DPD data samples in the captured DPD data samples are invalid, the processing module (240) is configured to:
increment an invalid data counter;
determine whether a count in the invalid data counter is above a threshold invalid data count; and
upon determining that the count is greater than the threshold invalid data count, trigger a transmit chain failure alarm.

14. The system claimed as in claim 10, wherein the processing module (240) is configured to:
determine whether a count of the low transmit power alarm counter is above a count threshold over a second pre-defined consecutive time period; and
upon determining that the count is above the count threshold over the second pre-defined consecutive time period, trigger the transmit chain failure alarm.

15. The system claimed as in claim 13, wherein when at least one DPD data sample of a first predefined number of DPD data samples is valid, the processing module (240) is configured to reset the invalid data counter to zero.

16. The system claimed as in claim 11, wherein determining the first transmit threshold value and the first feedback threshold value comprising:
capture the transmit power value and the feedback power value for a second predefined number of DPD data samples; and
determine a maximum value for the transmit power and the feedback power from the second predefined DPD data samples, wherein the maximum value determined for the first transmit power value is the first transmit threshold value and wherein the maximum value determined for the feedback power is the first feedback threshold value.

17. The system claimed as in claim 16, wherein for calculating the threshold value for the low transmit power alarm counter, the processing module (240) is configured to:
capture the transmit power value and the feedback power value for the predefined data samples; and
determine a minimum value for the transmit power and the feedback power from the predefined data samples, wherein the threshold value for the low transmit power alarm counter is the minimum value of the transmit power and the feedback power, respectively.

18. The system claimed as in claim 16, wherein the predefined number of DPD data samples comprises fifteen data samples, the predefined consecutive intervals are four and the first predefined consecutive time period and the second predefined consecutive time period are four hours.

19. A user equipment (104) communicatively coupled with a base station (110) via a network (106), wherein the base station (110) comprising a radio frequency antenna (112) communicating with a hardware alarm monitoring system (108), wherein the hardware alarm monitoring system is configured to:
capture a predefined number of digital pre-distortion (DPD) data samples from a DPD application over a pre-defined time period, wherein the DPD data samples include values of a transmit power to a radio frequency (RF) antenna (218) and a feedback power received from the RF antenna (218);
filter valid DPD data samples from the DPD data samples, wherein the DPD data sample is invalid if the transmit power or the feedback power is negative, infinity or zero and the DPD data sample is valid if a difference between the transmit power and the feedback power is less than a maximum difference between the transmit power and the feedback power;
analyze the valid DPD data samples to compare the transmit power against a first transmit threshold value and a second transmit threshold, and the feedback power against a first feedback threshold value and a second feedback threshold value;
upon determining that the transmit power and the feedback power are greater than the first transmit threshold value and the first feedback threshold value, respectively, increment, by the processing module (240), a high transmit power alarm counter; and
upon determining that the transmit power and the feedback power are less than the second transmit threshold value and the second feedback threshold value, respectively, increment by the processing module (240), a low transmit power alarm counter.

20. A computer program product comprising a non-transitory computer-readable medium comprising instructions that, when executed by one or more processors, cause the one or more processors to:
filter valid DPD data samples from the DPD data samples, wherein the DPD data sample is invalid if the transmit power or the feedback power is negative, infinity or zero and the DPD data sample is valid if a difference between the transmit power and the feedback power is less than a maximum difference between the transmit power and the feedback power;
analyze the valid DPD data samples to compare the transmit power against a first transmit threshold value and a second transmit threshold, and the feedback power against a first feedback threshold value and a second feedback threshold value;
upon determining that the transmit power and the feedback power are greater than the first transmit threshold value and the first feedback threshold value, respectively, increment, by the processing module (240), a high transmit power alarm counter; and
upon determining that the transmit power and the feedback power are less than the second transmit threshold value and the second feedback threshold value, respectively, increment by the processing module (240), a low transmit power alarm counter.
